(19) United States
(12) Patent Application Publication
(10) Pub. No.: US 2026/0196205 A1
(43) Pub. Date: Jul. 9, 2026

(54) DYNAMIC ADAPTATION OF REVERBERATION RENDERING

(71) Applicant: NOKIA TECHNOLOGIES OY, Espoo (FI)

(72) Inventors: Sujeet Shyamsundar Mate, Tampere (FI); Antti Johannes Eronen, Tampere (FI); Jussi Artturi Leppänen, Tampere (FI); Arto Juhani Lehtiniemi, Lempäälä (FI)

(21) Appl. No.: 19/133,320

(22) PCT Filed: Nov. 1, 2023
(86) PCT No.: PCT/EP2023/080463

§ 371 Date: May 28, 2025

(30) Foreign Application Priority Data
Nov. 30, 2022 (GB) 2218014.5

(51) Int. Cl. G10K 15/12

(52) U.S. Cl. CPC G10K 15/12

(57) ABSTRACT

A method for assisting generating reverberant audio signals, the method including: obtaining at least one reverberation parameter associated with at least one audio signal, the at least one reverberation parameter representing reverberation characteristics to be applied when rendering the associated at least one audio signal; obtaining at least one reverberation modification parameter configured to control a delay parameter during a generation of a reverberant audio signal based on the at least one reverberation parameter; and outputting or storing a bitstream including the at least one reverberation parameter, and the at least one reverberation modification parameter.

### FIELD

The present application relates to apparatus and methods for dynamic adaptation of reverberation rendering, but not exclusively for dynamic adaptation of reverberation rendering in augmented reality and/or virtual reality apparatus.

### BACKGROUND

Reverberation refers to the persistence of sound in a space after the actual sound source has stopped. Different spaces are characterized by different reverberation characteristics. For conveying spatial impression of an environment, reproducing reverberation perceptually accurately is important. Room acoustics are often modelled with individually synthesized early reflection portion and a statistical model for the diffuse late reverberation. FIG. 1 depicts an example of a synthesized room impulse response showing amplitude 101 over time 103 where the direct sound 105 is followed by discrete early reflections 107 which have a direction of arrival (DOA) and diffuse late reverberation 109 which can also have a direction of arrival or be synthesized without any specific direction of arrival.

One method of reproducing reverberation is to utilize a set of N loudspeakers (or virtual loudspeakers reproduced binaurally using a set of head-related transfer functions (HRTF)). The loudspeakers are positioned around the listener somewhat evenly. Mutually incoherent reverberant signals are reproduced from these loudspeakers, producing a perception of surrounding diffuse reverberation.

The positioning and the number of the loudspeakers suitable for producing the diffuse perception has been studied. Examples of which are K. Hiyama, S. Komiyama, and K. Hamasaki, The Minimum Number of Loudspeakers and Its Arrangement for Reproducing the Spatial Impression of Diffuse Sound Field, AES 113th Convention, 2002 and C. Kirch, J Poppitz, T. Wendt, S. van der Par, and S. Ewert, Spatial Resolution of Late Reverberation in Virtual Acoustic Environments. Submitted to Trends in Hearing (currently available at https://journals.sagepub.com/doi/full/10.1177/23312165211054924), 2021. It has been found that somewhere around 6-12 loudspeakers are required, depending on the positioning of the loudspeakers.

The reverberation produced by the different loudspeakers has to be mutually incoherent. In a simple case the reverberations can be produced using the different channels of the same reverberator, where the output channels are uncorrelated but otherwise share the same acoustic characteristics such as RT60 time and level (specifically, the diffuse-to-direct or diffuse-to-source ratio or reverberant-to-direct ratio). Such uncorrelated outputs sharing the same acoustic characteristics can be obtained, for example, from the output taps of a Feedback-Delay-Network (FDN) reverberator with suitable tuning of the delay line lengths, or from a reverberator based on using decaying uncorrelated noise sequences by using a different uncorrelated noise sequence for different channels. In this case, the different reverberant signals effectively have the same features, and the reverberation is typically perceived to be similar to all directions.

In some other cases, the reverberation to different loudspeakers can be tuned based on the acoustic environment. For example, in some cases it is desirable to adjust the spatial characteristics of reverberation depending on the direction from which that portion of the diffuse late reverberation originates from. An example is using a shorter RT60 time for reverberation signals originating from the direction of a highly absorbing wall versus using a longer RT60 time for reverberation signals originating from the directions corresponding to acoustically more reflecting materials. In this case, the reverberation is different to different directions.

### SUMMARY

There is provided according to a first aspect a method for assisting generating reverberant audio signals, the method comprising: obtaining at least one reverberation parameter associated with at least one audio signal, the at least one reverberation parameter representing reverberation characteristics to be applied when rendering the associated at least one audio signal; obtaining at least one reverberation modification parameter configured to control a delay parameter during a generation of a reverberant audio signal based on the at least one reverberation parameter; and outputting or storing a bitstream comprising the at least one reverberation parameter, and the at least one reverberation modification parameter.

The method may further comprise obtaining the at least one audio signal, wherein the bitstream further comprises the at least one audio signal.

Obtaining at least one reverberation delay modification parameter configured to control the delay parameter during a generation of the reverberant audio signal based on the at least one reverberation parameter may comprise determining at least one reverberation delay modification parameter based on a runtime change parameter.

The runtime change parameter may comprise at least one of: available bitrate for the bitstream; computational resources of an apparatus for generating the reverberant audio signals; an early reflection part quality determination; and an environment scene geometry representation determination.

The early reflection part quality determination may be based on whether the environment scene geometry is represented with meshes or voxels.

The at least one reverberation parameter associated with the at least one audio signal may comprise a delay parameter for late reverberation parts of the reverberation audio signal.

The delay parameter may be a pre-delay parameter configured to define a delay value to be applied before starting the late reverberation parts of the reverberation audio signal.

According to a second aspect there is provided a method for generating reverberant audio signals, the method comprising: obtaining a bitstream, the bitstream comprising: at least one reverberation parameter; and at least one reverberation modification parameter; obtaining at least one audio signal; generating a reverberant audio signal based on processing at least the at least one audio signal based on the at least one reverberation parameter; and controlling a delay parameter during the generation of the reverberant audio signal based on the at least one reverberation modification parameter, wherein the delay parameter for the reverberant audio signal generation is determined based at least partially on the at least one reverberation modification parameter.

The bitstream may further comprise the at least one audio signal.

Controlling a delay parameter during the generation of the reverberant audio signal based on the at least one reverberation modification parameter may further comprise determining the delay parameter of the late reverberation part of the reverberant audio signal.

Determining the delay parameter of the late reverberation part of the reverberant audio signal may comprise: determining an initial delay parameter based on the at least one reverberation parameter; and modifying the initial delay parameter based on the at least one reverberation modification parameter.

Modifying the initial delay parameter based on the at least one reverberation modification parameter may comprise modifying the initial delay parameter based on the at least one reverberation modification parameter based on determining at least one trigger event.

The trigger event may comprise at least one of: available bitrate for the bitstream; computational resources of an apparatus generating the reverberant audio signals; an early reflection part quality determination; and an environment scene geometry representation determination.

Controlling a delay parameter during the generation of the reverberant audio signal based on the at least one reverberation modification parameter may further comprise: determining whether early reflection parts of the reverberant audio signal are to be generated; and modifying the delay parameter of the late reverberation part of the reverberant audio signal with the application of the at least one reverberation modification parameter based on the determining whether early reflection parts of the reverberant audio signal are to be generated.

The delay parameter may be a pre-delay parameter configured to define a delay value to be applied before starting the late reverberation parts of the reverberation audio signal.

Generating a reverberant audio signal based on processing at least the at least one audio signal based on the at least one reverberation parameter may further comprise processing at least the at least one audio signal with a reverberator configured using the at least one reverberation parameter.

According to a third aspect there is provided an apparatus for assisting generating reverberant audio signals, the apparatus comprising means configured to: obtain at least one reverberation parameter associated with at least one audio signal, the at least one reverberation parameter representing reverberation characteristics to be applied when rendering the associated at least one audio signal; obtain at least one reverberation modification parameter configured to control a delay parameter during a generation of a reverberant audio signal based on the at least one reverberation parameter; and output or store a bitstream comprising the at least one reverberation parameter, and the at least one reverberation modification parameter.

The means may be further configured to obtain the at least one audio signal, wherein the bitstream further comprises the at least one audio signal.

The means configured to obtain at least one reverberation delay modification parameter configured to control the delay parameter during a generation of the reverberant audio signal based on the at least one reverberation parameter may be configured to determine at least one reverberation delay modification parameter based on a runtime change parameter.

The runtime change parameter may comprise at least one of: available bitrate for the bitstream; computational resources of an apparatus for generating the reverberant audio signals; an early reflection part quality determination; and an environment scene geometry representation determination.

The early reflection part quality determination may be based on whether the environment scene geometry is represented with meshes or voxels.

The at least one reverberation parameter associated with the at least one audio signal may comprise a delay parameter for late reverberation parts of the reverberation audio signal.

The delay parameter may be a pre-delay parameter configured to define a delay value to be applied before starting the late reverberation parts of the reverberation audio signal.

According to a fourth aspect there is provided an apparatus for generating reverberant audio signals, the apparatus comprising means configured to: obtain a bitstream, the bitstream comprising: at least one reverberation parameter; and at least one reverberation modification parameter; obtain at least one audio signal; generate a reverberant audio signal based on processing at least the at least one audio signal based on the at least one reverberation parameter; and control a delay parameter during the generation of the reverberant audio signal based on the at least one reverberation modification parameter, wherein the delay parameter for the reverberant audio signal generation is determined based at least partially on the at least one reverberation modification parameter.

The bitstream may further comprise the at least one audio signal.

The means configured to control a delay parameter during the generation of the reverberant audio signal based on the at least one reverberation modification parameter may further be configured to determine the delay parameter of the late reverberation part of the reverberant audio signal.

The means configured to determine the delay parameter of the late reverberation part of the reverberant audio signal may be configured to: determine an initial delay parameter based on the at least one reverberation parameter; and modify the initial delay parameter based on the at least one reverberation modification parameter.

The means configured to modify the initial delay parameter based on the at least one reverberation modification parameter may be configured to modify the initial delay parameter based on the at least one reverberation modification parameter based on determining at least one trigger event.

The trigger event may comprise at least one of: available bitrate for the bitstream; computational resources of an apparatus generating the reverberant audio signals; an early reflection part quality determination; and an environment scene geometry representation determination.

The means configured to control a delay parameter during the generation of the reverberant audio signal based on the at least one reverberation modification parameter may further be configured to: determine whether early reflection parts of the reverberant audio signal are to be generated; and modify the delay parameter of the late reverberation part of the reverberant audio signal with the application of the at least one reverberation modification parameter based on the determining whether early reflection parts of the reverberant audio signal are to be generated.

The delay parameter may be a pre-delay parameter configured to define a delay value to be applied before starting the late reverberation parts of the reverberation audio signal.

The means configured to generate a reverberant audio signal based on processing at least the at least one audio signal based on the at least one reverberation parameter may further be configured to process at least the at least one audio signal with a reverberator configured using the at least one reverberation parameter.

According to a fifth aspect there is provided an apparatus for assisting generating reverberant audio signals, the apparatus comprising at least one processor and at least one memory storing instructions that, when executed by the at least one processor, cause the system at least to perform: obtaining at least one reverberation parameter associated with at least one audio signal, the at least one reverberation parameter representing reverberation characteristics to be applied when rendering the associated at least one audio signal; obtaining at least one reverberation modification parameter configured to control a delay parameter during a generation of a reverberant audio signal based on the at least one reverberation parameter; and outputting or storing a bitstream comprising the at least one reverberation parameter, and the at least one reverberation modification parameter.

The apparatus may further be caused to perform obtaining the at least one audio signal, wherein the bitstream further comprises the at least one audio signal.

The apparatus caused to perform obtaining at least one reverberation delay modification parameter configured to control the delay parameter during a generation of the reverberant audio signal based on the at least one reverberation parameter may be caused to further perform determining at least one reverberation delay modification parameter based on a runtime change parameter.

The runtime change parameter may comprise at least one of: available bitrate for the bitstream; computational resources of an apparatus for generating the reverberant audio signals; an early reflection part quality determination; and an environment scene geometry representation determination.

The early reflection part quality determination may be based on whether the environment scene geometry is represented with meshes or voxels.

The at least one reverberation parameter associated with the at least one audio signal may comprise a delay parameter for late reverberation parts of the reverberation audio signal.

The delay parameter may be a pre-delay parameter configured to define a delay value to be applied before starting the late reverberation parts of the reverberation audio signal.

According to a sixth aspect there is provided an apparatus for generating reverberant audio signals, the apparatus comprising at least one processor and at least one memory storing instructions that, when executed by the at least one processor, cause the system at least to perform: obtaining a bitstream, the bitstream comprising: at least one reverberation parameter; and at least one reverberation modification parameter; obtaining at least one audio signal; generating a reverberant audio signal based on processing at least the at least one audio signal based on the at least one reverberation parameter; and controlling a delay parameter during the generation of the reverberant audio signal based on the at least one reverberation modification parameter, wherein the delay parameter for the reverberant audio signal generation is determined based at least partially on the at least one reverberation modification parameter.

The bitstream may further comprise the at least one audio signal.

The apparatus caused to perform controlling a delay parameter during the generation of the reverberant audio signal based on the at least one reverberation modification parameter may further be caused to perform determining the delay parameter of the late reverberation part of the reverberant audio signal.

The apparatus caused to perform determining the delay parameter of the late reverberation part of the reverberant audio signal may be further caused to perform: determining an initial delay parameter based on the at least one reverberation parameter; and modifying the initial delay parameter based on the at least one reverberation modification parameter.

The apparatus caused to perform modifying the initial delay parameter based on the at least one reverberation modification parameter may be caused to perform modifying the initial delay parameter based on the at least one reverberation modification parameter based on determining at least one trigger event.

The trigger event may comprise at least one of: available bitrate for the bitstream; computational resources of an apparatus generating the reverberant audio signals; an early reflection part quality determination; and an environment scene geometry representation determination.

The apparatus caused to perform controlling a delay parameter during the generation of the reverberant audio signal based on the at least one reverberation modification parameter may further be caused to perform: determining whether early reflection parts of the reverberant audio signal are to be generated; and modifying the delay parameter of the late reverberation part of the reverberant audio signal with the application of the at least one reverberation modification parameter based on the determining whether early reflection parts of the reverberant audio signal are to be generated.

The delay parameter may be a pre-delay parameter configured to define a delay value to be applied before starting the late reverberation parts of the reverberation audio signal.

The apparatus caused to perform generating a reverberant audio signal based on processing at least the at least one audio signal based on the at least one reverberation parameter may further be caused to perform processing at least the at least one audio signal with a reverberator configured using the at least one reverberation parameter.

According to a seventh aspect there is provided an apparatus for assisting generating reverberant audio signals, the apparatus comprising: obtaining circuitry configured to obtain at least one reverberation parameter associated with at least one audio signal, the at least one reverberation parameter representing reverberation characteristics to be applied when rendering the associated at least one audio signal; obtaining circuitry configured to obtain at least one reverberation modification parameter configured to control a delay parameter during a generation of a reverberant audio signal based on the at least one reverberation parameter; and outputting or storing circuitry configured to output or store a bitstream comprising the at least one reverberation parameter, and the at least one reverberation modification parameter.

According to an eighth aspect there is provided an apparatus for generating reverberant audio signals, the apparatus comprising: obtaining circuitry configured to obtain a bitstream, the bitstream comprising: at least one reverberation parameter; and at least one reverberation modification parameter; obtaining circuitry configured to obtain at least one audio signal; generating a reverberant audio signal based on processing at least the at least one audio signal based on the at least one reverberation parameter; and controlling circuitry configured to control a delay parameter during the generation of the reverberant audio signal based on the at least one reverberation modification parameter, wherein the delay parameter for the reverberant audio signal generation is determined based at least partially on the at least one reverberation modification parameter.

According to a ninth aspect there is provided a computer program comprising instructions [or a computer readable medium comprising instructions] for causing an apparatus, for assisting generating reverberant audio signals, the apparatus caused to perform at least the following: obtaining at least one reverberation parameter associated with at least one audio signal, the at least one reverberation parameter representing reverberation characteristics to be applied when rendering the associated at least one audio signal; obtaining at least one reverberation modification parameter configured to control a delay parameter during a generation of a reverberant audio signal based on the at least one reverberation parameter; and outputting or storing a bitstream comprising the at least one reverberation parameter, and the at least one reverberation modification parameter.

According to a tenth aspect there is provided a computer program comprising instructions [or a computer readable medium comprising instructions] for causing an apparatus, for generating reverberant audio signals, the apparatus caused to perform at least the following: obtaining a bitstream, the bitstream comprising: at least one reverberation parameter; and at least one reverberation modification parameter; obtaining at least one audio signal; generating a reverberant audio signal based on processing at least the at least one audio signal based on the at least one reverberation parameter; and controlling a delay parameter during the generation of the reverberant audio signal based on the at least one reverberation modification parameter, wherein the delay parameter for the reverberant audio signal generation is determined based at least partially on the at least one reverberation modification parameter.

According to an eleventh aspect there is provided a non-transitory computer readable medium comprising program instructions for causing an apparatus, for assisting generating reverberant audio signals, to perform at least the following: obtaining at least one reverberation parameter associated with at least one audio signal, the at least one reverberation parameter representing reverberation characteristics to be applied when rendering the associated at least one audio signal; obtaining at least one reverberation modification parameter configured to control a delay parameter during a generation of a reverberant audio signal based on the at least one reverberation parameter; and outputting or storing a bitstream comprising the at least one reverberation parameter, and the at least one reverberation modification parameter.

According to a twelfth aspect there is provided a non-transitory computer readable medium comprising program instructions for causing an apparatus, for generating reverberant audio signals, to perform at least the following: obtaining a bitstream, the bitstream comprising: at least one reverberation parameter; and at least one reverberation modification parameter; obtaining at least one audio signal; generating a reverberant audio signal based on processing at least the at least one audio signal based on the at least one reverberation parameter; and controlling a delay parameter during the generation of the reverberant audio signal based on the at least one reverberation modification parameter, wherein the delay parameter for the reverberant audio signal generation is determined based at least partially on the at least one reverberation modification parameter.

According to a thirteenth aspect there is provided an apparatus, for assisting generating reverberant audio signals, comprising: means for obtaining at least one reverberation parameter associated with at least one audio signal, the at least one reverberation parameter representing reverberation characteristics to be applied when rendering the associated at least one audio signal; means for obtaining at least one reverberation modification parameter configured to control a delay parameter during a generation of a reverberant audio signal based on the at least one reverberation parameter; and means for outputting or storing a bitstream comprising the at least one reverberation parameter, and the at least one reverberation modification parameter.

According to a fourteenth aspect there is provided an apparatus, for generating reverberant audio signals, comprising: means for obtaining at least one audio signal obtaining a bitstream, the bitstream comprising: at least one reverberation parameter; and at least one reverberation modification parameter; means for obtaining at least one audio signal; means for generating a reverberant audio signal based on processing at least the at least one audio signal based on the at least one reverberation parameter; and means for controlling a delay parameter during the generation of the reverberant audio signal based on the at least one reverberation modification parameter, wherein the delay parameter for the reverberant audio signal generation is determined based at least partially on the at least one reverberation modification parameter. According to a fifteenth aspect there is provided a computer readable medium comprising instructions for causing an apparatus, for generating reverberant audio signals, to perform at least the following: obtaining at least one reverberation parameter associated with at least one audio signal, the at least one reverberation parameter representing reverberation characteristics to be applied when rendering the associated at least one audio signal; obtaining at least one reverberation modification parameter configured to control a delay parameter during a generation of a reverberant audio signal based on the at least one reverberation parameter; and outputting or storing a bitstream comprising the at least one reverberation parameter, and the at least one reverberation modification parameter.

According to a sixteenth aspect there is provided a computer readable medium comprising instructions for causing an apparatus, for generating reverberant audio signals, to perform at least the following: obtaining a bitstream, the bitstream comprising: at least one reverberation parameter; and at least one reverberation modification parameter; obtaining at least one audio signal; generating a reverberant audio signal based on processing at least the at least one audio signal based on the at least one reverberation parameter; and controlling a delay parameter during the generation of the reverberant audio signal based on the at least one reverberation modification parameter, wherein the delay parameter for the reverberant audio signal generation is determined based at least partially on the at least one reverberation modification parameter.

An apparatus comprising means for performing the actions of the method as described above.

An apparatus configured to perform the actions of the method as described above.

A computer program comprising instructions for causing a computer to perform the method as described above.

A computer program product stored on a medium may cause an apparatus to perform the method as described herein.

An electronic device may comprise apparatus as described herein.

A chipset may comprise apparatus as described herein.

Embodiments of the present application aim to address problems associated with the state of the art.

### SUMMARY OF THE FIGURES

For a better understanding of the present application, reference will now be made by way of example to the accompanying drawings in which:

FIG. 1 shows a model of room acoustics and the room impulse response;

FIG. 2 shows schematically an example apparatus within which some embodiments may be implemented;

FIG. 3 shows effects of dynamic reverberation adjustment when applied according to some embodiments;

FIG. 4 shows a flow diagram of the operation of the example dynamic reverberation modifier as shown in FIG. 2 according to some embodiments;

FIG. 5 shows schematically an example FDN reverberator as shown in FIG. 2 according to some embodiments;

FIG. 6 shows schematically an example apparatus with transmission and/or storage within which some embodiments can be implemented; and

FIG. 7 shows an example device suitable for implementing the apparatus shown in previous figures.

### EMBODIMENTS OF THE APPLICATION

The following describes in further detail suitable apparatus and possible mechanisms for dynamic adjustment of reverberation during rendering of audio signals. Thus for example the suitable apparatus and methods can be part of a spatial audio rendering (also known as spatial rendering). The following examples and embodiments are suitable for inclusion into the MPEG-I Audio Phase 2 (ISO/IEC 23090-4) standard and also 3GPP SA4 IVAS codec designs, where for example it has been discussed to include parameters for modelling combined direct/early-reflections/late reverb binauralization.

Within the spatial audio rendering a reverberation spectrum or level can be controlled using the diffuse-to-direct ratio, which describes the ratio of the energy (or level) of reverberant sound energy to the direct sound energy (or the total emitted energy of a sound source). In N00054 MPEG-I Immersive Audio Encoder Input Format, the input to the encoder is provided as DDR (or DSR) value which indicates the ratio of the diffuse (reverberant) sound energy to the total emitted energy of a sound source. Another well-known measure is the RDR which refers to reverberant-to-direct ratio and which can be measured from an impulse response. The relation between these two, described in N0083_MPEG-I Immersive Audio CfP Supplemental Information, Recommendations and Clarifications, Version 1, is that

$$10 * log 10 ( R D R ) = 10 * log 10 ( D D R ) - 41 dB .$$

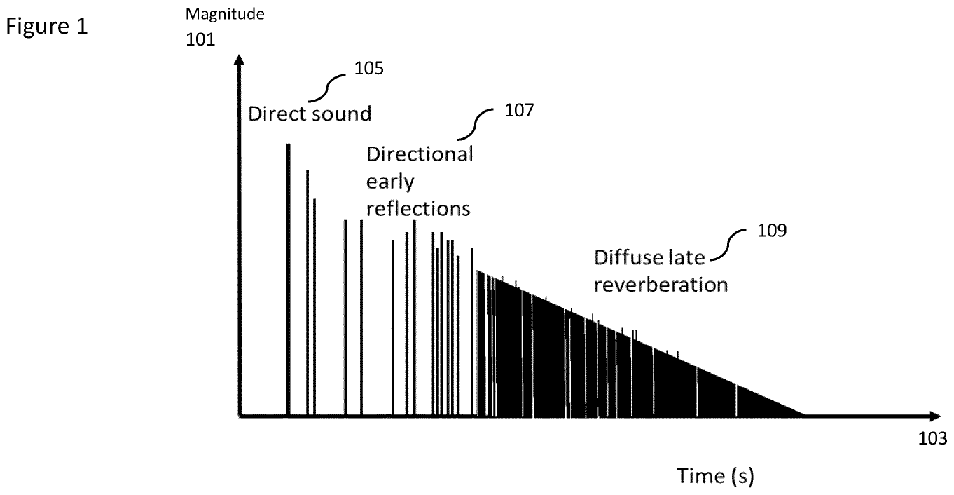

Referring to FIG. 1, the RDR can be calculated by performing the following operations:
summing the squares of the sample values of the diffuse late reverberation portion;
summing the squares of the sample values of the direct sound portion; and
calculating the ratio of these two sums to give RDR.

The logarithmic RDR can be obtained as 10*log 10 (RDR).

It is known to perform acoustic modelling of early reflections with high quality using knowledge of the geometry of the environment and the acoustic properties of the reflecting materials. The current working draft of the MPEG-I Immersive audio standard (ISO/IEC 23090-4) describes the acoustically relevant scene geometry using two approaches.

The first approach is known as the mesh-based approach which uses triangular meshes to indicate the scene geometry elements, acoustic environments, source extent, etc.

The second approach is known as the voxel-based approach which uses a compact representation of voxels to indicate the scene geometry.

The mesh-based approach provides greater definition and detail about the scene geometry to perform acoustic effect modelling. The complexity of this approach is controlled by including/excluding scene geometry as well as using the reflection order as a control parameter (for example a 1st order reflection refers to a reflection arriving after bouncing from a surface, a 2nd order reflection refers to reflections arriving after bouncing from two surfaces, and so on). The voxel-based approach is inherently less conducive to precise early reflections modelling, especially with the low granularity representation. This is due to the rough approximation of arbitrary scene geometry with “boxes” (i.e. the voxels).

There are known methods where a device is configured to optimize reverberation characteristics (or acoustic parameters) into reverberator parameters and then create a bitstream of the optimized reverberator parameters.

Furthermore there are known methods where high-perceptual-quality reverberation can be synthesized for physical environments in augmented reality if reverberation parameters are obtained only at the renderer.

Early reflections, occlusion and diffraction rendering are supported in ISO/IEC 23090-4 2nd version of MPEG-I Immersive Audio WD0, NO147 based on a mesh-based scene representation. A mesh-based scene representation provides a set of mesh faces to describe the surfaces which match the scene geometry element surfaces. Furthermore a mesh-based scene representation provides higher precision in representing the scene which results in higher quality acoustic effects rendering. A drawback of the mesh-based representation is that it can require more bits to represent such information. Another drawback is that it can be computationally expensive to perform the acoustic effect rendering with highly detailed geometry. The MPEG-I Immersive Audio specification indicated above also provides an alternative representation approach which depends on the use of voxels for scene representation. The voxel-based approach is more suitable for representing scene geometry with low precision and lower amount of bits. Some drawbacks with the voxel approach are that the surfaces of scene elements are approximated by voxels. Curved surfaces may therefore be approximated with cubes. Consequently, this representation is less suitable for performing early reflections acoustic effect rendering because the reflections would not match the scene visuals.

The MPEG-I renderer framework describes both the control workflow and the rendering workflow. In the following a workflow can be understood to be operations, steps or processes through which a piece of work passes from initiation to completion.

The renderer control workflow handles the 6 degrees-of-freedom (6DoF) scene. The control workflow therefore provides an interface for obtaining the bitstream, the listener space description format (LSDF) file in case of augmented reality (AR) scenes, an application programming interface (API) for updates (directly received by the renderer), clock synchronization and audio data. The main components associated with the control workflow are the scene controller which is configured to handle the maintenance of the information about the status of the scene as the scene information as well as changes are obtained via the bitstream, updates (local updates API), the LSDF, and the anchors. The anchors are implemented a spatial transform used for placing objects in an Augmented Reality (AR) scene. The position and orientation of the anchor is determined by the listener space description information received before the start of the rendering. This scene information can be maintained in the scene state of the renderer. The entities of the scene are represented as scene objects in the scene state. The renderer components may subscribe to know about individual scene object state or change in state. This can for example be performed via a SceneStateObserver interface. Each of the scene objects has an identifier, position, velocity, parent and an indicator defining whether the scene is static or otherwise. There are also special scene objects such as the Listener that do not have a parent and are not static. Scene objects such as the audio elements have additional attributes such as the ones described for Higher order ambisonics audio sources (HOASources), audio object sources (ObjectSources) and audio channel sources (ChannelSources) in an encoder input format (EIF) as indicated by Encoder Input Format for the MPEG-I Immersive Audio CFP, N0054.

There are geometry scene objects such as the Box, Sphere, Cylinder, Mesh, Transform and AR Anchors which can be obtained from the LSDF. Furthermore, changes in the audio scene can be specified as an update and can impact the various scene objects in the scene state. The stream manager can be configured to provide the received decoded audio data buffers to the renderer. Furthermore a clock component in the renderer can allow the renderer to synchronize the scene time to an external clock. In a standalone mode an internal CPU wall-clock is used.

The rendering workflow generates an aural representation of the scene for a listener using the information obtained from the control workflow. The acoustic effects are rendered in different rendering stages. The audio signals and the metadata can be processed in the renderer pipeline where the audio data and metadata are organized as a render list comprising render items. These render items pass through the render pipeline consisting of multiple renderer stages and terminating with a spatializer stage.

The reverberation or reverb stage in the renderer obtains as an input render items (RI) which are within the acoustic environment (AE) and not inactive. A render item refers to any audio element in the Renderer pipeline. A render item can represent an input audio content of the scene such as an audio object or be generated by the renderer as a result of acoustic effect processing such as an early reflection or a diffracted sound element. The Reverb stage can be configured to execute several Feedback Delay Network (FDN) reverberators in parallel, with one for each currently active AE, referred to as Reverberators (or more generally as a reverberator). The parameters for each FDN are optimized according to the reverberation characteristics of the corresponding AE. The Reverb stage reads the reverb payload to obtain acoustic parameters based on which reverberator parameters are obtained to initialize or configure the FDN reverberators.

To generate a complete reverberation for an audio scene the reverb stage is employed with an early reflection stage (EarlyReflectionStage). Whereas the Reverb Stage renders the late reverberation portion based on acoustic parameters of an environment the EarlyReflectionStage is configured to render discrete early reflections based on the acoustic material and geometry description parameters of the audio scene. Additionally the renderer is configured to adjust a predelay depending on the used early reflection order to ensure that the early reflection portion and late reverberation portion blend well together. The predelay configures the length of a delay line before the reverberator and can be used to add additional delay if required by the acoustic parameters or used early reflection order so that the early reflections and late reverberation blend together well. Generally, a lower early reflection order requires a higher value for the predelay in order to shift the late reverberation part earlier in the synthesized impulse response and ensure that there is no gap between the early reflection portion and the late reverberation portion. The predelay can in embodiments be controlled with a predelay factor (predelayFactor) which is used to divide an input acoustic predelay to obtain the desired reverberator predelay. Thus, a rendering predelay can be obtained as acousticPredelay/predelayFactor. acousticPredelay in MPEG-I has been defined to be equal to:

$${t}_{predelay} = 4 * \frac{{d}_{l o n g e s t}}{c} ,$$

with c=343 m/s, the speed of sound, and d_{longest} is the largest axis of the bounding volume (in m).

When controlling the predelay for a reverberator, in embodiments the delay of the reverberator can be taken into account. This means that if the reverberator has inherent delay, this can be subtracted (or otherwise taken into account) when performing additional delay to reach desired predelay. For example, the length of the shortest delay line of a delay-based reverberator can be subtracted from the desired rendering predelay when adding additional delay before the reverberator to reach the desired rendering predelay.

In addition, a voxel-based occlusion stage can provide occlusion information with respect to a direct path (i.e., a line-of-sight) from the audio source to the listener. A voxel-based diffraction stage can be configured to provide information required for generating diffracted sounds around any occluding objects. The diffraction stage can be configured to use information that is provided by the occlusion stage.

The 3GPP IVAS codec, which is a 3DoF communications audio codec, can possibly support control data for reverberation rendering in binauralization. Such control data can enable the decoder side binauralization to add suitable room effect containing early reflections and/or late reverberation in addition to the direct sound. This kind of acoustic effect is particularly suitable in augmented reality (AR) or mixed reality (XR) applications.

For some usage scenarios, such as ones where content is streamed or downloaded over the air and especially where the end user device is moving such as a mobile phone or a vehicle, it is desirable for the bitrate required for 6DoF reverberation rendering for virtual environments to be configurable for different available bandwidths. This is to ensure fast content download speed, uninterrupted streaming, and/or fast playback startup for different available network bandwidth amounts.

Since early reflections modelling data for 6DoF scenes can be bandwidth intensive depending on the scene geometry and the number of audio sources and the order of early reflections, the quality and quantity of early reflections data is typically modified based on the available bitrate.

To enable bitrate adaptation by modifying the quality and quantity of early reflections data, one possibility is to implement a limited set of bitstream representations available for early reflections metadata. This can be the case when such data is pre-generated and stored, which limits the step size for bitrate adaptation (e.g., typical scenario for MPEG-DASH based streaming servers).

Another way to enable bitrate scalability is to change between a mesh-based and voxel-based scene geometry representation. The mesh-based scene representation enables high-quality diffraction modelling as well as high quality early reflections modelling. As described above a voxel-based scene representation is not suitable for early reflections modelling with high quality. Consequently, if the renderer selects a voxel-based scene representation for rendering, this will result in suboptimal representation for early reflections modelling.

Since early reflection metadata or scene geometry representation can have varying quality and quantity depending on available bandwidth, it is desirable to develop methods that can produce high quality reverberation while the early reflection parameters are adjusted based on the available bandwidth and/or connectivity. Thus, such a method needs to ensure that early reflection rendering and reverberation rendering happen in synchrony.

Where the early reflection rendering and reverberation rendering is not synchronized poor user experience and immersion can occur. Furthermore reverberation rendering is not reacting or adapting to the change in early reflection rendering. If early reflections are completely missing, the late reverberation can start with a too long pre-delay leaving a long gap between the direct sound and late diffuse reverberation. Furthermore if early reflections are rendered with a lower order than for which the late diffuse reverberation has been configured for, then there can be gap between the first early reflections and the late diffuse reverberation.

The concept as discussed in the embodiments in further detail herein is one which relates to reproduction of reverberation in 6DoF audio rendering systems based on acoustic scene early reflection and reverberation parameters. In these embodiments the encoder or scene generator is configured to generate and then transmit and/or store parameters enabling reverberation adaptation to changing early reflections rendering in response to dynamically changing bitrate to aim to achieve high quality reverberation rendering under variable early reflection parameter bitstream size.

This can for example be accomplished in some embodiments within the encoder/scene generator by the following method steps:
obtain trigger information comprising runtime change parameters (e.g., available bitrate, computational resources) impacting early reflections parameter encoding and/or rendering;
obtain reverberation parameters associated with the virtual environment;
obtain reverberation predelay modification parameters based on the trigger information; and
encode into bitstream the reverberation parameters and predelay modification parameters.

Furthermore this can be incorporated within the decoder/renderer by implementing in some embodiments the following method:
obtain from a bitstream reverberation parameters;
obtain a reverberation predelay modification parameter either from bitstream or based on a trigger information;
determine a reverberator predelay based at least partly on the reverberation predelay modification parameter;
receive at least one input signal associated with the virtual environment and render an immersive output audio signal where diffuse late reverberation is rendered using the reverberator parameters while adjusting the predelay based on the reverberation predelay modification parameter.

In some embodiments, the trigger information is at least one of run-time rendering complexity, early reflections quality, early reflections order, scene geometry representation format, or bitrate.

Additionally in some embodiments the reverberation predelay modification parameter depends on the trigger information.

The predelay modification parameter in some embodiments indicates how the reverberator predelay is to be adjusted such that the impulse response of the early reflections and the impulse response of the late reverberation blend well together.

In some embodiments, the early reflections quality is determined based on whether the scene geometry relevant for early reflections rendering is represented with meshes or voxels.

In some embodiments, the predelay for the diffuse late reverberator can be obtained from the bitstream.

The bitstream, in some embodiments, carries information about the predelay value for diffuse late reverberation associated with the current parameterization of the early reflections (the trigger information).

In some embodiments, the bitstream carries an indication for adaptation of the predelay value for diffuse late reverberation associated with the current parameterization of the early reflections (the trigger information).

If the player selects, in some embodiments, an acoustic scene geometry representation for low bitrate or low complexity rendering, the renderer can be configured to drop the early reflections rendering effect if the selected acoustic scene geometry representation is not suitable (the trigger information).

Subsequently, the renderer can be configured to adjust the predelay to compensate for the absence of early reflections.

For example, where an audio scene is represented with mesh and coarse voxel-based representations, if the player selects a coarse voxel-based representation, the player or renderer can be configured to determine that the scene representation is not suitable for performing high quality early reflections rendering. Consequently, the player or renderer is configured to switch off the early reflections rendering (the trigger information) and at the same time adjust the predelay for diffuse late reverberation rendering to maintain high quality immersion.

Although the MPEG-I Audio Phase 2 will normatively standardize the bitstream and the renderer processing, and there will also be an encoder reference implementation. The encoder implementation can be modified (later on) as long as the output bitstream from the encoder follows the normative specification. This allows situations such as described herein which aim to improve the codec quality (also after the standard has been finalized) with novel encoder implementations.

The embodiments as described herein can be considered as having portions which can be mapped to different parts of the MPEG-I standard as described herein:

The normative bitstream can contain the parameter which provides information for the derivation of the modified predelay for diffuse late reverberation rendering.

The normative renderer shall decode the bitstream to derive or obtain the modified predelay value and perform diffuse late reverberation rendering to maintain as immersive audio as feasible.

The normative renderer can also perform the complete steps of obtaining the trigger information for predelay modification, and modification of the reverberator predelay accordingly.

As described above, some embodiments and examples, such as described above can be implemented within a 3GPP IVAS codec in a similar manner as described herein. In 3GPP IVAS, the encoder side processing is also normative. Although the IVAS codec is not configured to process 6DoF movement (but rather is configured to implement 3DoF movement of the rendering user) which means that the rendering side can be configured to operate in a manner similar to the examples herein which describe 6DoF rendering. The difference in the IVAS based embodiments is that listener translation motion or displacement is not taken into account. As at least some operating modes of 3GPP IVAS are aimed at lower complexity operating points then the reverberation rendering is preferably computationally a lightweight implementation. The following examples provide a suitable mechanism as they enable computational complexity reduction and/or bitrate adaptation to be implemented without significant loss in audio quality as the late reverberation predelay can be shortened if early reflections are not provided or are missing the higher orders of reflections. For example, in a dynamic bitrate adaptation the early reflection parameters can be dropped because of a reduction in available bitrate which means that the reverberator rendering will need to react by shortening the predelay in order to maintain good audio quality. Furthermore with respect to the IVAS codec the spatialization of reverberator outputs can be implemented via direct binauralization, for example, via summing of delay line outputs to two channels if very low computational complexity is desired.

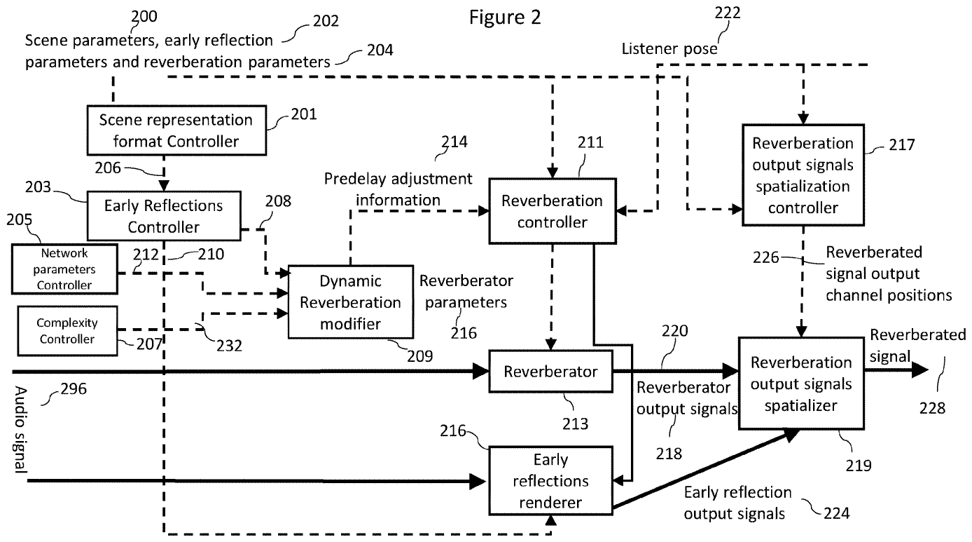

With respect to FIG. 2 is shown example apparatus for demonstrating some embodiments. The example apparatus can be implemented within a renderer or playback apparatus.

In some embodiments the input to the system of apparatus comprises scene parameters 200, early reflection parameters 202 and reverberation parameters 204. The scene parameters 200, early reflection parameters 202 and reverberation parameters 204 in some embodiments can be obtained from a retrieved 6DoF rendering bitstream such as provided by a suitable bitstream.

Additionally the input to the system of apparatus comprises an audio signal 296 which can be obtained from the retrieved audio data and which in some embodiments is provided by the suitable obtained bitstream.

The system furthermore is configured to obtain listener pose information 222. The listener pose information is based on the orientation and/or position of the listener or user of the playback apparatus.

In some embodiments the system of apparatus comprises a network parameters controller 205 configured to generate network bitrate information 212. In some embodiments the network parameters controller 205 is external to this system of apparatus and the apparatus configured to receive or otherwise obtain the network bitrate information 212.

Furthermore, in some embodiments the system of apparatus comprises a complexity controller 207 configured to generate complexity information 232. In some embodiments the complexity controller 207 is external to this system of apparatus and the apparatus configured to receive or otherwise obtain the complexity information 232.

In some embodiments the apparatus comprises a scene representation format controller 201. The scene representation format controller 201 in some embodiments is configured to obtain the scene parameters 200 and the early reflection parameters 202. The scene representation format controller 201 is then configured to determine whether the available format is suitable for early reflections rendering. This format control information 206 and the scene parameters 200, early reflection parameters 202 and reverberation parameters 204 can then be passed to the early reflections controller 203.

The early reflections controller 203 is configured to receive the format control information 206 and scene parameters 200, early reflection parameters 202 and reverberation parameters 204 and signal, with an early reflection controller signal 208, the dynamic reverberation modifier 209 to modify the reverberation parameters 204.

In some embodiments the system of apparatus comprises a dynamic reverberation modifier 209. The dynamic reverberation modifier 209 is configured to obtain from the network parameter controller 205 the network bitrate information 212 and from the complexity controller 207 the complexity information 232. The dynamic reverberation modifier 209 is further configured to obtain the scene parameters 200, early reflection parameters 202 and reverberation parameters 204 along with the early reflection controller signal 208. The dynamic reverberation modifier 209 in some embodiments is configured to generate a predelay adjustment information 214 which can be passed to a reverberation controller 211.

In some embodiments the apparatus comprises a reverberation controller 211. The reverberation controller 211 is configured to obtain the scene parameters 200, early reflection parameters 202 and reverberation parameters 204. Additionally the reverberation controller 211 is configured to obtain the predelay adjustment information 214 from the dynamic reverberation modifier 209. The reverberation controller 211 is further configured to obtain the listener pose 222.

From these inputs the reverberation controller 211 is configured to generate reverberator parameters 216 which are passed to a reverberator 213 and further configured to generate (early) reflection signaling 218 parameters which can be passed to the early reflections renderer 215.

In some embodiments the reverberator 213 is configured to obtain the reverberator parameters 216 and the audio signal 296 and generate reverberator output audio signals 220 based on the configuration of the reverberator controlled by the reverberator parameters 216.

Furthermore the apparatus comprises the early reflections renderer 215 which is configured to obtain the audio signal 296 and the early reflections parameters 210. The early reflections renderer 215 is then configured by the early reflections parameters 210 which is then enabled to generate early reflection output audio signals 224 based on the audio signal 296 input.

The system of apparatus furthermore comprises a reverberation output signals spatializer controller 217. The reverberation output signals spatializer controller 217 is configured to obtain the listener pose information and the scene parameters 200, early reflection parameters 202 and reverberation parameters 204 and from these generate reverberated signal output channel positions 226 which can be passed to a reverberation output signals spatializer 219.

In some embodiments the system of apparatus comprises a reverberation output signals spatializer 219. The reverberation output signals spatializer 219 is configured to receive the reverberator output audio signals 220 and the early reflections output audio signals 224 as well as the reverberated signal output channel positions 226 and generate the reverberated audio signal 228.

The example system of apparatus shown in FIG. 2 can therefore provide reverberated audio signal comprising diffuse late reverberation. In addition, the output can comprise early reflections if it is selected for rendering (e.g. binauralized with head-related-transfer-function (HRTF) filtering for reproduction to headphones, or panned with Vector-Base Amplitude Panning (VBAP) for reproduction to loudspeakers). The output in this example comprises reverberation contribution from early reflections and diffuse late reverberation. The rendering of the two components is described below:

The diffuse late reverberation rendering operation can be implemented as shown above based on the scene parameters 200 and reverberation parameters 204 being received or obtained by the reverberation controller 211. The scene parameters 200 and reverberation parameters 204 in some embodiments being in the form of a bitstream which contains enclosing room geometry and parameters describing the RT60 times and reverberant-to-direct ratio (RDR) for the enclosure. Alternatively, a diffuse-to-source energy ratio (DSR) or other suitable parameter describing the reverberation ratio or energy can be used. In addition, the scene parameters 200 can comprise the scene geometry information which can be a mesh-based representation format or voxel-based representation format.

The reverberation controller furthermore as described above is configured to obtain from the bitstream reverberation parameters 204 and convert the encoded reverberation parameters into parameters suitable for configuring the reverberator 213. These reverberator parameters 216 can then initialize at least one (FDN) reverberator 213 to reproduce reverberation according to the reverberator parameters 216. The reverberator 213 is therefore configured to reproduce the reverberation according to the characteristics of an acoustic environment, where the corresponding reverberator parameters are derived from. In an example embodiment, the reverberation parameters are derived by an encoder based on acoustic environment RT60 and DDR parameters and written into a bitstream, which the apparatus of FIG. 2 is configured to receive.

The reverberator 213 can therefore be configured to obtain or receive the reverberator parameters 216, which also receives the audio signal 296 sᵢₙ(t) (where t is time). The reverberator 213 reverberates the audio signal 296 based on the reverberator parameters 216 and an activation.

The resulting reverberator output audio signals 220 s_{rev,r} (j,t) (where j is the output audio channel index and r the reverberator index) are output from the reverberator and passed to a reverberation output signals spatializer 219.

The reverberation output signals spatializer 219 is configured to produce an output signal suitable for reproduction via headphones or via loudspeakers. The reverberation output signals spatializer 219 also receives the reverberator output channel positions 226 from the reverberator output signals spatialization controller 217. The reverberator output channel positions 226 in some embodiments indicates the Cartesian coordinates which are to be used when rendering the each of the signals in s_{rev,r} (j,t). In alternative embodiments other representations such as polar coordinates (or any other suitable co-ordinate system) can be used.

The reverberation output signals spatializer 219 as described above can therefore render each reverberator output to a desired output format such as binaural and then sum the signals to produce the output reverberated audio signal 228. For binaural reproduction the reverberation output signals spatializer 219 can be configured to employ HRTF filtering to render the reverberator output audio signals 220 in their desired positions indicated by the reverberator output channel positions 226.

For generation of early reflections rendering, the early reflection parameters 202 can be audio scene acoustic element geometric properties and their acoustic material properties. The early reflections renderer 215 in some embodiments is configured to synthesize early reflections, based on sound propagation from sound sources traced via the reflecting planes (audio scene elements with acoustic materials) to the listener. The propagation path length defines the delay which needs to be applied in a delay line to the signal and also the amount of attenuation. Additional attenuation is applied based on material properties of each reflecting surface which the reflection reflects from. The impact of absorption of several reflections is accumulated in case the reflection propagates through more than one wall. A certain order of early reflections can be simulated in this manner and encoded into higher order ambisonics or any other suitable format for auralization.

The resulting early reflection output audio signals 224 can then be forwarded, as described above, to the reverberation output signals spatializer 219 where the early reflections output signals as well as the reverberation output signals are spatialized and combined (for example summed together).

In some embodiments the early reflection parameters 202 are the audio scene geometry information and the acoustic material properties of the audio scene elements which cause the reflection of the direct sound emanating from the audio sources in the audio scene. Depending on the scene representation format and network bitrate availability information, the early reflections metadata retrieval is impacted. Consequently, the early reflections controller 203 in some embodiments is configured to select an appropriate early reflections rendering approach, which can be selecting the early reflections order, the early reflections method and decide whether to continue early reflections rendering.

Depending on the suitability of scene geometry information for early reflections rendering (e.g., mesh-based scene information is suitable for high quality early reflection rendering) and availability of early reflections rendering metadata the proper order and early reflection rendering method is selected. If the scene geometry information is in the form of voxel-based representation, lower quality early reflections rendering is possible, however, the benefit is lower bitrate and lower computational complexity requirement. If the renderer is constrained by scene representation format or bitrate or computational complexity, the rendering of early reflections can be stopped or paused. Thus in some embodiments the early reflections controller can be configured to select from three possible scenarios for early reflections rendering:
A. Rendering early reflections with full quality and highest available order bitstream due to sufficient bitrate and suitable scene geometry representation (e.g., mesh-based scene geometry)
B. Rendering early reflections with lower quality due to lower bitrate or unsuitable scene geometry representation format (e.g., voxel-based scene geometry) or complexity limitations
C. Stopping or pausing rendering of early reflections due to one or more constraints regarding bitrate, scene representation, bitrate and complexity

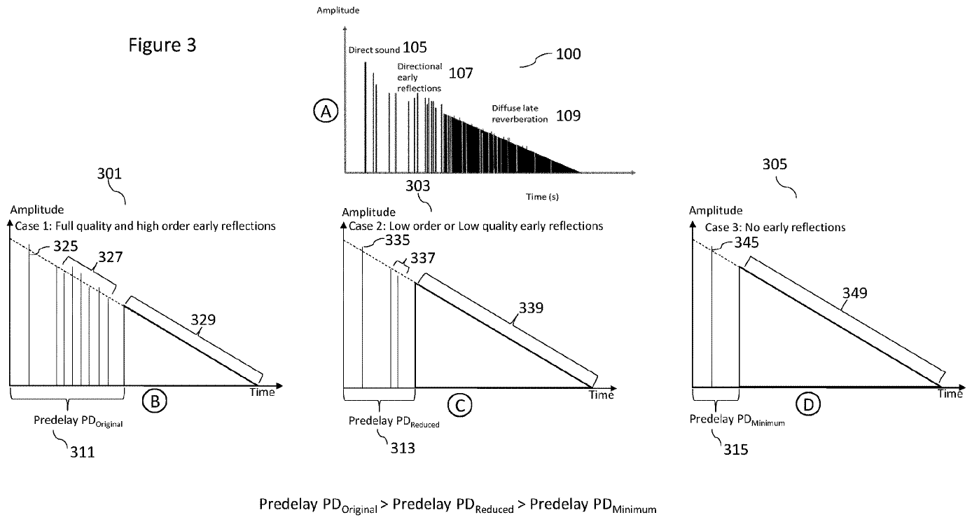

With respect to FIG. 3 is shown examples of the effect of embodiments on an example room impulse response. For example the example A as shown by the room impulse response 100 shows the room impulse response as shown previously in FIG. 1 with direct sound 105 components, directional early reflection components 107 and diffuse late reverberation components 109. As can be seen the presence of early reflections provides an important ingredient of a full impulse response. Furthermore with respect to 6DoF audio rendering, an absence of an acoustic effects such as early reflections as well as diffuse late reverberation is important for an immersive audio experience. As such the embodiments are configured to compensate for the absence or suboptimal presence of early reflections rendering.

As discussed earlier, the absence or reduced quality early reflections rendering can be due to various bottlenecks such as network bitrate, scene representation format, or complexity.

Furthermore FIG. 3 in B 301 shows an example room impulse response where the early reflections are rendered with high quality (enabled by suitable scene geometry representation, higher order early reflections metadata is enabled by higher bitrate and sufficient computational resources for rendering the high order early reflections). Consequently, there can be shown clearly the direct 325, early reflections (with several orders) 327 and diffuse late reverberation 329 parts. In this situation there is no need to modify the predelay and thus the value (PDOriginal) 311 can be used for diffuse late reverberation in the diffuse late reverberation metadata in the 6DoF bitstream metadata. Thus, late reverberation can start after the early reflection portion at a relatively large predelay compared to the situation where the early reflection order were lower.

Additionally FIG. 3 in C 303 shows an example room impulse response where the early reflections are rendered with lower quality, either due to lower order (e.g., first order) due to bitrate constraints or computational constraints. The same may be caused due to unsuitable scene geometry representation. Consequently, there can be shown clearly the direct 335, early reflections (with one or two orders) 337 and diffuse late reverberation 339 parts. In this situation there is a need to modify the predelay and thus the predelay is modified to PDreduced 313. The modification of the predelay parameter is performed based on information obtained from the bitstream guiding the renderer or derived by the renderer based on the network bitrate, complexity budget, acoustic effect rendering parameters (e.g., early reflections order) or a combination of both. The reduction of the predelay is implemented in order to cause the impulse response of the late reverberator to fill in the gap left by lower quality and/or sparser early reflections in order to minimize audio quality degradation such as perception of sparse early reflections and/or too long delay before reverberation.

Furthermore is shown in FIG. 3, the example D 305 where the apparatus is configured to stop or pause the operation of rendering early reflections.

Consequently, there can be shown clearly the direct 345 and diffuse late reverberation 349 parts (but no early reflections). In this situation the predelay is reduced to PDminimum 315. This results in compensation for the missing early reflections using the diffuse late reverberation impulse response and ensures an immersive audio experience with appropriate perception of delay of room reverberation. In this case the first impulses of a nonideal digital reverberator serve to act as a rough approximation of (discrete) early reflection pulses after the diffuse portion of the reverberator starts.

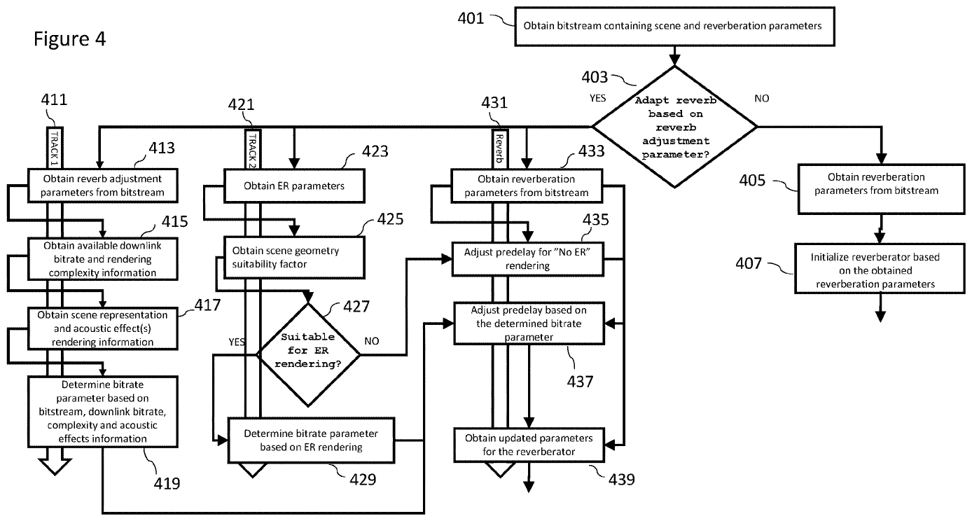

FIG. 4 describes a flow diagram of the example method implemented by the dynamic reverberation modifier 214 for the generating of the pre-delay adjustment information.

Thus in some embodiments the first operation is one of obtaining the bitstream containing scene and reverberation parameters as shown by 401.

Then a decision is made for modifying the reverberation parameters based on the received bitstream information. In other words the renderer is configured to determine whether the adaptation of diffuse late reverberation parameters to compensate for absence or reduced quality acoustic effect rendering (e.g., early reflections) should be performed as shown by 403.

Where it is determined that there is no adaptation then reverberation parameters from the bitstream are obtained as shown by 405.

Then the reverberator is initialized based on the obtained reverberation parameters as shown by 407 and the reverberator is then operated.

The flow diagram shows three tracks, where the first two tracks (Track 1 411 and Track 2 421) are two different paths for determination of parameter for adjustment of predelay.

In this example Track 1 411 can be a generic approach which utilizes the bitstream provided guidance in combination with bitrate, complexity and scene representation format suitability to determine the adjustment of predelay.

Track 1 411 thus shows the following operations:
obtaining reverberation adjustment parameters from the bitstream as shown by 413;
obtaining available downlink bitrate and rendering complexity information as shown by 415;
obtaining scene representation and acoustic effects rendering information as shown by 417; and determining a bitrate parameter based on the bitstream, downlink bitrate, complexity and acoustic effects information as shown by 419.

Track 2 421 utilizes early reflections rendering parameters to determine the adjustment of the predelay. Track 2 421 comprises the operations of: obtaining the early reflection parameters as shown by 423;
obtaining the scene geometry suitability factor as shown by 425;
determining the suitability for early reflection rendering as shown by 427; and
when determining the suitability of early reflection rendering then determining a bitrate parameter based on the early reflection rendering as shown by 429.

The reverb track 431 uses the input from one of the tracks (track 1 411 or track 2 421) to adjust the reverb predelay dynamically to obtain updated parameters for the reverberator. The reverb track 431 thus comprises the operations of:
obtaining reverberation parameters from the bitstream as shown by 422;
adjusting a predelay parameter based on a no early reflection determination (from 427) as shown by 435;
adjusting a predelay based on the determined bitrate parameter determination (from 419 or 429 based on whether track 1 411 or track 2 421 is followed) as shown by 437; and
then there is an operation, following the adjustment (or non-adjustment) of the predelay time of obtaining the updated parameters for the reverberator as shown by 439.

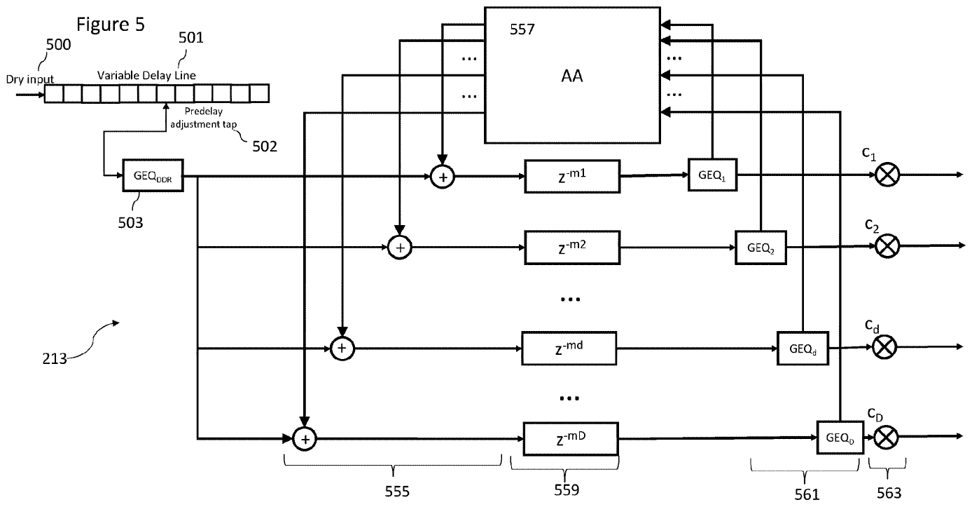

FIG. 5 illustrates a typical FDN reverberator which is preceded by a dynamic delay line to enable dynamic predelay adjustment.

Thus is shown the reverberator 213 which is configured to receive or obtain a ‘dry’ input 500. The (FDN) reverberator 213 shows apparatus which can be used to produce D uncorrelated output audio signals.

In some embodiments the FDN reverberator 213 comprises a variable delay line 501, where the predelay adjustment tap 502 (set based on the predelay parameter) is used to generate the predelay time. In some embodiments the length M of the variable predelay delay line is set equal to the desired predelay subtracted by the length of the shortest delay line of the FDN reverberator. This causes the first pulses of the FDN reverberator to occur after predelay time. The M sample variable delay line can be implemented, for example, using separate read- and write-pointers into a sufficiently long memory buffer. The length N of the delay line buffer is set larger than possible values of M, e.g., equal to the longest supported predelay plus some safety margin. The following pseudo code can be used to implement such a variable length delay line:

```
static float buf [N];
static float *readPointer = buf;
static float *writePointer = buf;
void setDelay(int M)
{
    readPointer = writePointer − M;
    while (readPointer < buf)
    {
        readPointer += N;
    }
}
float delayLine(float x)
{
  float y;
  buf[writePointer++] = x;
  y = buf[readPointer++];
  if ((writePointer-buf) >= N)
  {
      writePointer −= N
  }
  if ((readPointer-A) >= N)
  {
      readPointer −= N
  }
  return y;
}
```

When the predelay is modified impacting the delay M of the predelay line, in some embodiments the change is applied gradually. Thus, when receiving a new predelay causing a different length for the predelay line \hat{M}, the change from M to \hat{M} can be done gradually. For example, the length of the predelay line can be modified by one sample within each audio buffer until the new predelay line length \hat{M} is achieved. This can in embodiments help reduce audible artefacts. In some other embodiments, the change can be implemented instantaneously. In some embodiments there can be a bitstream parameter controlling whether the change is to be applied instantaneously or gradually, and in the case of gradual application optionally the length of the gradual transition region.

In an embodiment of the implementation, the dynamic predelay modification is controlled directly by the renderer based on the order of early reflections modelling, the format of the scene geometry representation (e.g., mesh versus voxel). In another embodiment of the implementation, the dynamic predelay modification is controlled via the system interface, for example, based on available bitrate and complexity constraints. In yet another embodiment, the implementation leverages renderer based predelay modification in combination with the system interface feedback regarding the bitrate or complexity constraints.

The output of the predelay adjustment tap 502 of the variable delay line 501 can be passed to a DDR energy ratio control filter GEQ_{DDR} 503.

The example FDN reverberator 213 is configured such that the reverberation parameters are processed to generate coefficients GEQ_{d} (GEQ₁, GEQ₂, . . . GEQ_{D}) of the attenuation filters 561, feedback matrix 557 coefficients A, lengths m_{d} (m₁, m₂, . . . m_{D}) for D delay lines 559 and DDR energy ratio control filter 503 coefficients GEQ_{ddr}. The DDR energy ratio control filter 503 can also be referred as RDR energy ratio control filter or reverberation ratio control filter or reverberation equalization or coloration filter. The purpose of such a filter is to adjust the level and spectrum according to the RDR or other reverberation ratio data.

In some embodiments the theoretical approximation is used to adjust input reverberation ratio values (DSR or RDR or other suitable representation). The ratio values RDRᵢₙ(k) determined at a first predelay (e.g. the predelay=t_{predelay}) to a second predelay=t₂. This second predelay t₂ can be such a predelay which is used for rendering the reverberation with the Reverberator.

If the input RDR values RDRlog were obtained at predelay t_{predelay}. The method can calculate RDRlog data at the second predelay=t₂.

With the adjustment the DRDlog are obtained as

$$RDRlog ( k ) = 10 {log}_{10} ( R D {R}_{i n} ( k ) ) + 60. * ( predelayDifference / RT 60 ( k ) )$$

where predelayDifference=t_{predelay}−t₂ and the term +60.0*(predelayDifference/RT60 (k)) is the adjustment.

This adjustment allows approximating the RDR values when reverberation is to be rendered starting from a predelay different from the predelay at which the values are obtained, and to approximate the adjustment that needs to be done to the DDR values. Referring to FIG. 3, in the case the RDR values are provided at predelay PDOriginal 311, then the above method can be used to calculate, for example, the RDR values corresponding to the predelay PDReduced 313 or PDMinimum 315. The impact is that the late reverberation level is scaled in level according to the changing predelay, in addition to shifting backwards in time which is implemented by the predelay line.

In some embodiments the attenuation filter GEQ_{d} 561 is implemented as a graphic EQ filter using M biquad IIR band filters. With octave bands M=10, thus, the parameters of the graphic EQ comprise the feedforward and feedback coefficients for biquad IIR filters, the gains for biquad band filters, and the overall gain.

The reverberator uses a network of delays 559, feedback elements (shown as attenuation filters 561, feedback matrix 557 and combiners 555 and output gain 563) to generate a very dense impulse response for the late part. Input samples are input to the reverberator to produce the reverberation audio signal component which can then be output.

The FDN reverberator comprises multiple recirculating delay lines. The unitary matrix A 557 is used to control the recirculation in the network. Attenuation filters 561 which may be implemented in some embodiments as graphic EQ filters implemented as cascades of second-order-section IIR filters can facilitate controlling the energy decay rate at different frequencies. The filters 561 are designed such that they attenuate the desired amount in decibels at the pulse pass through the delay line and such that the desired RT60 time is obtained.

With octave bands M=10, thus, the parameters of the graphic EQ comprise the feedforward b and feedback a coefficients for 10 biquad IIR filters, the gains for biquad band filters, and the overall gain.

The number of delay lines D can be adjusted depending on quality requirements and the desired tradeoff between reverberation quality and computational complexity. In an embodiment, an efficient implementation with D=15 delay lines is used. This makes it possible to define the feedback matrix coefficients A as proposed by Rocchesso in Maximally Diffusive Yet Efficient Feedback Delay Networks for Artificial Reverberation, IEEE Signal Processing Letters, Vol. 4. No. 9, September 1997, in terms of a Galois sequence facilitating efficient implementation.

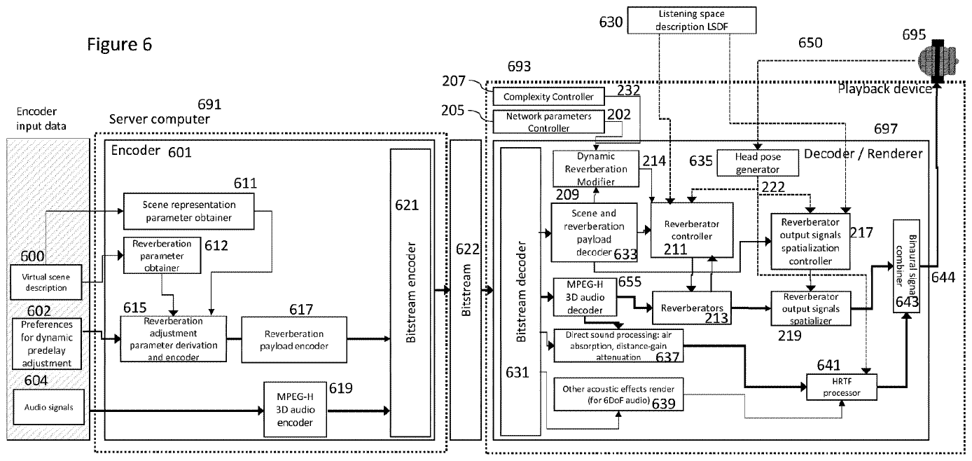

With respect to FIG. 6 is shown schematically an example system where the embodiments are implemented by a server 691 which writes data into a bitstream 622 and transmits that for a playback device 693, which decodes the bitstream, performs reverberator processing according to the embodiments and outputs audio for headphone listening.

FIG. 6 therefore shows apparatus, and specifically the renderer device 697, which is suitable for performing spatial rendering operations.

The server 691 in some embodiments can be performed on content creator computers and/or network server computers. The server 601 in some embodiments comprises an encoder 601 which can generate the bitstream 622 which is made available for downloading or streaming (or storing). The playback device 693 furthermore can comprise a decoder/renderer 697 functionality and which can be a mobile device, personal computer, sound bar, tablet computer, car media system, home HiFi or theatre system, head mounted display for AR or VR, smart watch, or any suitable system for audio consumption.

The encoder 601 is configured to receive the virtual scene description 600 and the audio signals 604. The virtual scene description 600 can be provided in the MPEG-I Encoder Input Format (EIF) or in other suitable format. Generally, the virtual scene description contains an acoustically relevant description of the contents of the virtual scene, and contains, for example, the scene geometry as a mesh or voxel, acoustic materials, acoustic environments with reverberation parameters, positions of sound sources, and other audio element related parameters such as whether reverberation is to be rendered for an audio element or not.

In some embodiments the encoder 601 comprises a scene representation parameter obtainer 611 configured to obtain the virtual scene description 600 and generate suitable scene parameters.

Furthermore the encoder 601 can comprise in some embodiments a reverberation parameter obtainer 613 which is configured to obtain the virtual scene description 600 and generate suitable reverberation parameters.

The encoder 601 furthermore is configured to receive or otherwise obtain the preferences for dynamic predelay adjustment 602. The preferences for dynamic predelay adjustment 602, in some embodiments, comprises one or more predelays which are associated with different operating scenarios. In an embodiment, the preferences for dynamic predelay adjustment can comprise predelayFactor suitable for different scenarios. An example includes predelayFactor of eight in the case of no early reflections, a predelayFactor of six in case of first order early reflections and a predelayFactor of four in case of second order early reflections.

In some embodiments the encoder 601 comprises a reverberation adjustment parameter determiner and encoder 615 configured to receive or obtain the obtained scene representation parameters and the reverberation parameter and the preferences for dynamic predelay adjustment and based on these generate encoded reverberation adjustment parameters.

Furthermore, in some embodiments, the encoder 601 comprises a reverberation payload encoder 617 configured to obtain the determined reverberation adjustment parameters (and more generally scene representation parameters and reverberation parameters) and generate a suitable encoded payload.

In some embodiments the scene and reverberation parameters are encoded into a bitstream payload referred as payloadReverb( )

As first example, the dynamic reverb modification information is included optionally in the reverb payload.

```
payloadReverb( )
aligned(8) payloadReverb( ){
  unsigned int(2) numberDelayLineSpatialPositions;
  for (int i = 0; i < numberOfDelayLineSpatialPositions; i++) {
    signed int(16) delayLineAzimuth;
    signed int(16) delayLineElevation;
  }
  unsigned int(8) numberOfAcousticEnvironments;
  for (int j = 0; j < numberOfAcousticEnvironments; j++) {
    unsigned int(16) acousticEnvironmentId;
    filterParams( );
    for (int k = 0; k < numberOfDelayLineSpatialPositions; k++)
{
      unsigned int(32) delayLineLength;
      filterParams( );
    }
  }
  unsigned int(1) dynamicReverbAdjPresent;
  unsigned int(32) reverbSpeedOfSound;
  bit(6) reserved = 0;
  if(dynamicReverbAdjPresent)
    DynamicReverbAdjustmentStruct( );
  else
    unsigned int(32) predelayFactorFixed;
}
aligned(8) filterParamsStruct( ){
  SOSLength;
  If(SOSLength>0){
    for (i=0;i<SOSLength;i++){
      signed int(32) b1;
    }
    for (i=0;i<SOSLength;i++){
      signed int(32) b2;
    }
    for (i=0;i<SOSLength;i++){
      signed int(32) a1;
    }
    for (i=0;i<SOSLength;i++){
      signed int(32) a2;
    }
  signed int(32) globalGain;
  signed int(32) levelDb;
  }
}
```

In the above structure format reverbPayloadStruct( ) there can be the following:

numberDelayLineSpatialPositions defines the number of output delay line positions for the late reverb payload. This value can be defined using an index which corresponds to a specific number of delay lines. The value of the bit string ‘0b00’ signals to the renderer a value of 15 spatial orientations for delay lines. The other three values ‘0b01’, ‘0b10’ and ‘0b11’ can be reserved.

delayLineAzimuth defines azimuth of the delay line with respect to the listener. The range is between-180 to 180 degrees.

delayLineElevation defines the elevation of the delay line with respect to the listener. The range is between-90 to 90 degrees.

numberOfAcousticEnvironments defines the number of acoustic environments in the audio scene. The reverbPayloadStruct( ) carries information regarding the one or more acoustic environments which are present in the audio scene at that time. An acoustic environment has certain reverberation parameters such as RT60 times which are used to obtain FDN reverb parameters.

acousticEnvironment Id defines the unique identifier of the acoustic environment.

delayLineLength defines the length in units of samples for the graphic equalizer (GEQ) filter used for configuration of the delay line attenuation filter. The lengths of different delay lines corresponding to the same acoustic environment are mutually prime.

dynamicReverbAdj Present is equal to 1 if the dynamic reverb adjustment metadata is present in the DynamicReverbAdjustmentStruct( ) If this flag is equal to 0, only a fixed predelay factor predelayFactorFixed is present.

filterParamsStruct( ) describes the graphic equalizer cascade filter to configure the attenuation filter for the delay lines. The same structure can also be used subsequently to configure the filter for diffuse-to-direct reverberation ratio GEQ_{DDR}. The details of this structure are described in a later table.

DynamicReverbAdjustmentStruct( ) describes the metadata to dynamically configure the predelay for the reverberator rendering stage in the renderer. This is different from the usual behaviour in absence of the invention, where a fixed predelay along with the reverberation parameters is used for the entire duration of reverb rendering until the reverberation parameters specified in the scene are not changed. This structure can carry two types of metadata in the bitstream for dynamic reverb adjustment. The first is the RendererTriggerStruct( ) and the second is the GuidedTriggerStruct( ).

In some embodiments the payloadReverb( ) structure can be defined as the following:

```
payloadReverb( )
reverbPayloadStruct( ){
  unsigned int(8) numberOfAcousticEnvironments;
  for(int i=0;i<numberOfAcousticEnvironments;i++){
    unsigned int(16) environmentsId;
    EncodedRT60Struct( );//frequency values can be differentially
and Huffman coded with values for RT60 values. So basically it will be 2
unsigned int per frequency bin.
    EncodedDDRStruct( );
    ReverbEnclosureStruct( );
    unsigned int(1) aeDynamicReverbAdjPresent;
    bit(7) reserved = 0;
    if(aeDynamicReverbAdjPresent)
      DynamicReverbAdjustmentStruct( );
    else
      unsigned int(32) aePredelayFactorFixed;
  }
  unsigned int(1) glDynamicReverbAdjPresent;
  unsigned int(32) reverbSpeedOfSound;
  bit(7) reserved = 0;
  if(gDynamicReverbAdjPresent)
    DynamicReverbAdjustmentStruct( );
  else
    unsigned int(32) gPredelayFactorFixed;
}
aligned(8) PositionStruct( ){
  signed int(32) vertex_pos_x;
  signed int(32) vertex_pos_y;
  signed int(32) vertex_pos_z;
}
aligned(8) ReverbEnclosureStruct( ){
  unsigned int(8) num_vertices; //vertices for the enclosure
  for(i=0;i<num_vertices;i++) {
    PositionStruct( );
  }
}
aligned(8) EncodedRT60Struct( ){
  unsigned int(8) num_frequency_bands;
  for (i=0;i<num_frequency_bands;i++){
    unsigned int(32) frequency_encoded_value;
    unsigned int(32) scene_rt60_encoded_value;
  }
}
aligned(8) EncodedDDRStruct( ){
  unsigned int(8) num_frequency_bands;
  for (i=0;i<num_frequency_bands;i++){
    unsigned int(32) frequency_encoded_value;
    unsigned int(32) scene_ddr_encoded_value; //represented as
logRDR, Huffman coded
  }
}
aligned(8) DynamicReverbAdjustmentStruct( ){
  unsigned int(1) rendererTriggerPresent;
  unsigned int(1) guidedTriggerPresent;
  bit(6) reserved = 0;
  if(rendererTriggerPresent){
    RendererTriggerStruct( );
  }
  if(guidedTriggerPresent)
    GuidedTriggerStruct( );
  }
}
//Renderer implementation determines predelay adjustment levels for each
trigger
aligned(8) RendererTriggerStruct( ){
  unsigned int(8) numAdjustmentTriggers;
  for(int i=0, i< numAdjustmentTriggers, i++){
    unsigned int(8) predelayAdjustmentTriggers;
    unsigned int(8) predelayAdjustmentType;
  }
}
//Define predelay adjustment levels for each trigger in the bitstream
for guidance
aligned(8) GuidedTriggerStruct( ){
  unsigned int(1) erTriggerPresent;
  unsigned int(1) sceneRepresentationTriggerPresent;
  unsigned int(1) bitrateTriggerPresent;
  unsigned int(1) complexityTriggerPresent;
  bit(4) reserved = 0;
  if(erTriggerPresent)
    signed int(8) ERTriggerStruct( );
  if(sceneRepresentationTriggerPresent)
    signed int(8) SceneRepresentationTriggerStruct( );
  if(otherEffectsTriggerPresent)
    signed int(8) OtherAcousticEffectsTriggerStruct( );
}
aligned(8) ERTriggerStruct( ){
  unsigned int(4) numERTriggerInfo;
  for (int i=0, i< numERTriggerInfo, i++){
    unsigned int(4) earlyReflectionsType;
    unsigned int(1) earlyReflectionsMethod;
    bit(3) reserved = 0;
    if(earlyReflectionsType == 0)//NO ER
      unsigned int(8) predelayFactor;
    if(earlyReflectionsType ==
1||earlyReflectionsMethod!=1)//First Order ER
      unsigned int(8) predelayFactor;
    if(earlyReflectionsType == 2)// Second Order ER
      unsigned int(8) predelayFactor;
    if(earlyReflectionsType == 3)//Third Order ER
      unsigned int(8) predelayFactor;
    if(earlyReflectionsType == 4)// highest detail ER metadata
      unsigned int(8) predelayFactor;
    if(earlyReflectionsType == 5)//Lowest complexity required
for ER
      unsigned int(8) predelayFactor;
    if(earlyReflectionsType == 6)//Lowest bitrate required for
ER
      unsigned int(8) predelayFactor;
  }
}
aligned(8) SceneRepresentationTriggerStruct( ){
  unsigned int(4) sceneRepresentationType;
  if(sceneRepresentationType == 0)//Voxel based
    unsigned int(8) predelayFactor;
  if(sceneRepresentationType == 1)//Mesh based scene representation
    unsigned int(8) predelayFactor;
}
aligned(8) OtherAcousticEffectsTriggerStruct( ){
  unsigned int(8) numAcousticEffectTriggers;
  for(int i=0, i< numAcousticEffectTriggers, i++){
    unsigned int(8) AcousticEffectAbsentType;
    unsigned int(8) predelayFactor;
  }
}
```

In such embodiments the reverbPayloadStruct( ) can feature EncodedRT60Struct( ) which carries RT60 (scene_rt60_value) values for each frequency band (frequency_value) represented as positive integers. In an implementation embodiment, the integers are differentially encoded and Huffman coded integer indices.

EncodedDDRStruct( ) which carries DDR values (scene_ddr_coded_value) for each frequency (frequency_value) band represented as positive integers. In an implementation embodiment, the DDR value is represented according to 10*log 10 (RDR)=10*log 10 (DDR)−41 dB, the integers are differentially encoded and Huffman coded integer indices.

The frequency bands can be the same or different for RT60 and DDR. The Huffman coding of differences can be same or different for RT60 and DDR.

Regarding the dynamic reverb adjustment metadata, the second example carries this information as per acoustic environment as well as at a global level. This enables the content creator to have AE specific values for selected AEs as well as provide a global guidance for others. In some embodiments, only the per AE specific values may be present or only the global parameters may be present.

aeDynamicReverbAdj Present is equal to 1 if the dynamic reverb adjustment metadata is present for the particular acoustic environment in the DynamicReverbAdjustmentStruct( ) If this flag is equal to 0, only a fixed predelay factor aePredelayFactorFixed is present.

gDynamicReverbAdj Present is equal to 1 if the dynamic reverb adjustment metadata is present at the level in the global DynamicReverbAdjustmentStruct( ).

If DynamicReverbAdjustmentStruct( ) is present both, at AE level as well as global level, then the AE level parameter overrides the global level parameters. If flag is equal to 0, only a fixed predelay factor gPredelayFactorFixed is present. If both aePredelayFactorFixed as well as gPredelayFactorFixed is present for a certain AE, the aePredelayFactorFixed overrides.

In some embodiments the RendererTriggerStruct( ) can be defined in the following manner, and enumerates the triggers for which the renderer should monitor and determine the predelay modifications based on renderer implementation. These can, for example be the following.

| predelayAdjustmentTriggers | Value |
|---|---|
| NoEarlyReflectionsRendering | 0 |
| VoxelBasedScene | 1 |
| EarlyReflectionsMeshBasedScene | 2 |
| LowComputationResourceDetection | 3 |
| LowBatteryDetection | 4 |
| LowBitrateDetection | 5 |
| OneOrderLowerERRendering | 6 |
| LowerQualityERMethodRendering | 7 |
| Reserved | 8-255 |

predelayAdjustmentType enumerates when the modified predelay parameter should be applied for the reverb rendering and the type of effect (crossfade or without crossfade) the change in the reverb parameters should be delivered to the output.

| predelayAdjustmentType | Value |
|---|---|
| ImmediateNoCrossfade | 0 |
| ImmediateWithCrossfade | 1 |
| RendererDeterminedAdjTime | 2 |
| Reserved | 3-255 |

In some embodiments the GuidedTriggerStruct( ) Is configured to carry metadata for guiding the renderer to make the predelay modification based on the scene representation format. A mesh-based scene representation requires more bitrate in contrast to the voxel-based scene representation. However, the latter is less suitable for early reflections rendering compared to the former. Consequently, a larger predelayFactor is required for the rendering of reverb with voxel-based rendering, because early reflections rendering may be skipped. Alternatively, a method that is less dependent on the scene geometry details is used, which may result in lower subjective quality early reflections.

ERTriggerStruct( ) enumerates the predelay factor to be used for dynamic predelay adjustment depending on the method for early reflections, the order of early reflections (i.e. the number of hits the ray emanating from the source to the reflecting elements in the scene description). In addition there is guidance predelay factor for the situation where the player prefers to work with low computational complexity, low network bitrate.

| earlyReflectionsMethod | Value |
|---|---|
| Low complexity early reflections method | 0 |
| High quality early reflections method | 1 |

| earlyReflectionsType | Value |
|---|---|
| No early reflections rendering | 0 |
| First order early reflections rendering | 1 |
| Second order early reflections rendering | 2 |
| Third order early reflections rendering | 3 |
| Same detail as highest detail ER metadata | 4 |
| announced or available in the bitstream | |
| Lowest complexity required for ER rendering | 5 |

SceneRepresentationTriggerStruct( ) enumerates the predelay factor to be used for dynamic predelay adjustment depending on the method for early reflections, the order of early reflections (i.e. the number of hits the ray emanating from the source to the reflecting elements in the scene description). In addition there is guidance predelay factor for the situation where the player prefers to work with low computational complexity, low network bitrate. Please note that the above is determined by the renderer based on the instantaneous choice of scene representation. A scene may be described with both representations, but the 6DoF player may use a particular representation type based on network, complexity or other preference parameters.

| sceneRepresentationType | Value |
|---|---|
| Voxel-based scene representation | 0 |
| Mesh-based scene representation | 1 |
| Reserved | 2-255 |

OtherAcousticEffectsTriggerStruct( ) enumerates the predelay factor to be used for dynamic predelay adjustment depending on the acoustic effects that are not renderer.

| AcousticEffectAbsentType | Value |
|---|---|
| Reserved | 0 |
| Diffraction rendering not performed | 1 |
| Reserved | 2-255 |

In some embodiments the filterParamsStruct( ) can define the following: SOSLength is the length of the each of the second order section filter coefficients. b1, b2, a1, a2 The filter is configured with coefficients b1, b2, a1 and a2. These are the feedforward and feedback IIR filter coefficients of the second-order section IIR filters.

globalGain specifies the gain factor in decibels for the GEQ.

levelDB specifies a sound level offset for each of the delay lines in decibels.

All filterParamsStruct( ) get deserialized into a GEQ object in the renderer.

The encoder 601 further comprises a MPEG-H 3D audio encoder 619 configured to obtain the audio signals 604 and MPEG-H encode them and pass them to a bitstream encoder 621.

The encoder 601 furthermore in some embodiments comprises a bitstream encoder 621 which is configured to receive the output of the reverberation payload encoder 617 and the encoded audio signals from the MPEG-H encoder 619 and generate the bitstream 622 which can be passed to the bitstream decoder 631. The bitstream 622 in some embodiments can be streamed to end-user devices or made available for download or stored.

In other words this information can be made available to the 6DoF audio players via the server computer 691. The server 691 hosts the 6DoF bitstream which includes the rendering metadata, reverb adjustment metadata and also the audio data which is encoded in a suitable format. In case of MPEG-I implementations the audio data is encoded as MPEG-H. Typically the bitstream for 6DoF rendering and the MPEG-H coded audio data is stored at the server. The relevant bitstream and audio data is retrieved by the player. In some embodiments other implementation options are feasible such as broadcast, multicast. The server could be the origin server. In case of content distribution networks (CDNs), the origin server data, the bitstream 622, can be mirrored in one or more CDN point of presence nodes. However this CDN detail is not shown in the figure for brevity.

The playback device 693 in some embodiments is configured to receive or otherwise obtain the bitstream 622, and furthermore can be configured to receive or otherwise obtain the listening space description 630 (which can in some embodiments be in a listening space description format), which defines the acoustic properties of the listening space within which the user or listener is operating in. Additionally in some embodiments the playback device is configured to obtain, for example from the head mounted device (HMD) 695, listener orientation or position information 650. These can for example be generated by sensors within the HMD 695 or from sensors in the environment sensing the orientation or position of the listener.

In some embodiments the playback device 693 comprises a complexity controller 207, which is configured to operate in a manner similar to that described above and generate complexity information 232, which can be passed to a dynamic reverberation modifier 209.

Furthermore is shown that, in some embodiments the playback device 693 comprises a network parameters controller 205, which is configured to operate in a manner similar to that described above and generate network parameter information 212, which can be passed to the dynamic reverberation modifier 209.

The playback device in some embodiments comprises a decoder/renderer 697 which can comprise a bitstream decoder 631 configured to decode the bitstream.

The decoder/renderer 697 further can comprise a scene and reverberation payload decoder 633 configured to obtain the encoded scene and reverberation parameters (and any preferences for dynamic predelay adjustment information) and decode these in an opposite or inverse operation to the reverberation payload encoder 617.

The complexity information, network parameters information and the decoded scene and reverberation parameters can be passed to the dynamic reverberation modifier 209 which is configured to implement dynamic reverberation parameter modification or adjustment in a manner similar to that described above. These dynamically adjusted or modified reverberation parameters can be passed to the reverberation controller 211.

In some embodiments the decoder/renderer 697 comprises a head pose generator 635 which is configured to receive information from a head mounted device or similar and generates head pose information or parameters which can be passed to the reverberator controller 211, reverberator output signals spatialization controller 212 and HRTF processor 641

The decoder/renderer 697, in some embodiments, comprises a reverberator controller 211 which is configured to obtain the listening space description 630, the modified reverberation parameters 214, the decided scene and reverberation parameters and the head pose information 222 can be passed to the reverberation controller 211 which is configured to initialize or configure the (FDN) reverberator 213.

The renderer/decoder 697 in some embodiments comprises reverberator output signals spatialization controller 217 and reverberator output signals spatializer 219 which are configured to operate in a manner a described above to generate reverberated early and later parts) and pass these to the binaural signal combiner 643.

The renderer/decoder 697 in some embodiments comprises a MPEG-H 3D audio decoder 655 which is configured to decode the audio signals and pass them to the (FDN) reverberator 213 and direct sound processor 637.

The renderer/decoder 697 furthermore comprises the (FDN) reverberator 213 initialized by the reverberator controller 211 and configured to implement a suitable reverberation of the audio signals.

The output of the (FDN) reverberator 213 is configured to output to a reverberator output signals spatializer 219.

Additionally the decoder/renderer 697 comprises a direct sound processor 637 which is configured to receive the decoded audio signals and configured to implement any direct sound processing such as air absorption and distance-gain attenuation and which can be passed to a HRTF processor 641.

In some embodiments the decoder/renderer 697 comprises an other/further acoustic effects processor/renderer 639. The other/further acoustic effects processor/renderer 639 is configured to receive information from the decoded bitstream and generate further effect information which can be passed to the HRTF processor 641.

The HRTF processor can be configured to receive the output of the direct sound processor 637 and other acoustic effects processor/renderer 639 and generate processed audio signals associated with the processed direct audio components to the binaural signal combiner 643.

The binaural signal combiner 643 is configured to combine the direct and reverberant parts to generate a suitable output 644 (for example for headphone reproduction).

The output can be passed to the head mounted device 695.

The playback device 693 can be implemented in different form factors depending on the application. In some embodiments the playback device is equipped with its own listener position tracking apparatus or receives the listener position information from an external apparatus. The playback device can in some embodiments be also equipped with headphone connector to deliver output of the rendered binaural audio to the headphones.

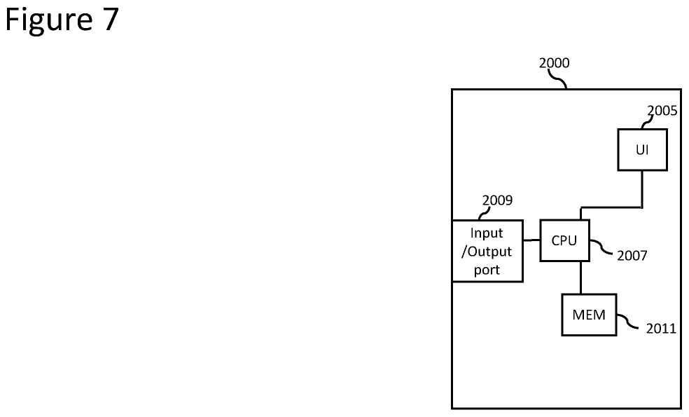

With respect to FIG. 7 an example electronic device which may be used as any of the apparatus parts of the system as described above. The device may be any suitable electronics device or apparatus. For example in some embodiments the device 2000 is a mobile device, user equipment, tablet computer, computer, audio playback apparatus, etc. The device may for example be configured to implement the encoder or the renderer or any functional block as described above.

In some embodiments the device 2000 comprises at least one processor or central processing unit 2007. The processor 2007 can be configured to execute various program codes such as the methods such as described herein.

In some embodiments the device 2000 comprises a memory 2011. In some embodiments the at least one processor 2007 is coupled to the memory 2011. The memory 2011 can be any suitable storage means. In some embodiments the memory 2011 comprises a program code section for storing program codes implementable upon the processor 2007. Furthermore in some embodiments the memory 2011 can further comprise a stored data section for storing data, for example data that has been processed or to be processed in accordance with the embodiments as described herein. The implemented program code stored within the program code section and the data stored within the stored data section can be retrieved by the processor 2007 whenever needed via the memory-processor coupling.

In some embodiments the device 2000 comprises a user interface 2005. The user interface 2005 can be coupled in some embodiments to the processor 2007. In some embodiments the processor 2007 can control the operation of the user interface 2005 and receive inputs from the user interface 2005. In some embodiments the user interface 2005 can enable a user to input commands to the device 2000, for example via a keypad. In some embodiments the user interface 2005 can enable the user to obtain information from the device 2000. For example the user interface 2005 may comprise a display configured to display information from the device 2000 to the user. The user interface 2005 can in some embodiments comprise a touch screen or touch interface capable of both enabling information to be entered to the device 2000 and further displaying information to the user of the device 2000. In some embodiments the user interface 2005 may be the user interface for communicating.

In some embodiments the device 2000 comprises an input/output port 2009. The input/output port 2009 in some embodiments comprises a transceiver. The transceiver in such embodiments can be coupled to the processor 2007 and configured to enable a communication with other apparatus or electronic devices, for example via a wireless communications network. The transceiver or any suitable transceiver or transmitter and/or receiver means can in some embodiments be configured to communicate with other electronic devices or apparatus via a wire or wired coupling.

The transceiver can communicate with further apparatus by any suitable known communications protocol. For example in some embodiments the transceiver can use a suitable universal mobile telecommunications system (UMTS) protocol, a wireless local area network (WLAN) protocol such as for example IEEE 802.X, a suitable short-range radio frequency communication protocol such as Bluetooth, or infrared data communication pathway (IRDA).

The input/output port 2009 may be configured to receive the signals.

In some embodiments the device 2000 may be employed as at least part of the renderer. The input/output port 2009 may be coupled to headphones (which may be a headtracked or a non-tracked headphones) or similar.

Thus in summary the embodiments as described above show:

A normative bitstream comprising:
Information specifying the triggers and the guidance parameters for dynamically modifying the reverb predelay parameter;
a bitstream description the parameters for which the renderer is expected to react (e.g., lower order early reflections, complexity or network bottleneck, etc.) and modifying the reverberation rendering dynamically based on the triggers.

Additionally in some embodiments the normative bitstream comprises trigger and predelay modification parameters described using the syntax described herein. The bitstream in some embodiments is streamed to end-user devices or made available for download or stored.

In some embodiments the normative renderer is configured to decode the bitstream to obtain the scene, reverberation parameters and dynamic reverb adjustment parameters and perform the modification to reverberator parameters as described herein. Moreover in some embodiments the renderer is configured to implement reverberation and early reflections rendering.

In some embodiments the complete normative renderer can also obtain other parameters from the bitstream related to room acoustics and sound source properties, and use them to render the direct sound, diffraction, sound source spatial extent or width, and other acoustic effects in addition to diffuse late reverberation and early reflections.

Thus in summary the concept is on in which there is the capacity for dynamic modification of rendering of reverberation based on the various triggers specified in the bitstream to enable bitrate and computational scalability based on suboptimal early reflections or other missing acoustic effects.

In general, the various embodiments of the invention may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The embodiments of this invention may be implemented by computer software executable by a data processor of the mobile device, such as in the processor entity, or by hardware, or by a combination of software and hardware. Further in this regard it should be noted that any blocks of the logic flow as in the Figures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD.

The memory may be of any type suitable to the local technical environment and may be implemented using any suitable data storage technology, such as semiconductor-based memory devices, magnetic memory devices and systems, optical memory devices and systems, fixed memory and removable memory. The data processors may be of any type suitable to the local technical environment, and may include one or more of general-purpose computers, special purpose computers, microprocessors, digital signal processors (DSPs), application specific integrated circuits (ASIC), gate level circuits and processors based on multi-core processor architecture, as non-limiting examples.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, California and Cadence Design, of San Jose, California automatically route conductors and locate components on a semiconductor chip using well established rules of design as well as libraries of pre-stored design modules. Once the design for a semiconductor circuit has been completed, the resultant design, in a standardized electronic format (e.g., Opus, GDSII, or the like) may be transmitted to a semiconductor fabrication facility or “fab” for fabrication.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
I hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

The term “non-transitory,” as used herein, is a limitation of the medium itself (i.e., tangible, not a signal) as opposed to a limitation on data storage persistency (e.g., RAM vs. ROM).

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements

The foregoing description has provided by way of exemplary and non-limiting examples a full and informative description of the exemplary embodiment of this invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention as defined in the appended claims.

1. A method for assisting generating reverberant audio signals, the method comprising:
obtaining at least one reverberation parameter associated with at least one audio signal, the at least one reverberation parameter representing reverberation characteristics to be applied when rendering the associated at least one audio signal;
obtaining at least one reverberation modification parameter configured to control a delay parameter during a generation of a reverberant audio signal based on the at least one reverberation parameter; and
outputting or storing a bitstream comprising the at least one reverberation parameter, and the at least one reverberation modification parameter.

2. The method as claimed in claim 1, further comprising obtaining the at least one audio signal, wherein the bitstream further comprises the at least one audio signal.

3. The method as claimed in claim 1, wherein obtaining the at least one reverberation modification parameter comprises determining at least one reverberation delay modification parameter based on a runtime change parameter.

4. The method as claimed in claim 3, wherein the runtime change parameter comprises at least one of:
available bitrate for the bitstream;
computational resources of an apparatus for generating the reverberant audio signals;
an early reflection part quality determination; or
an environment scene geometry representation determination.

5. The method as claimed in claim 4, wherein the early reflection part quality determination is based on whether the environment scene geometry is represented with meshes or voxels.

6. The method as claimed in claim 1, wherein the at least one reverberation parameter comprises the delay parameter for late reverberation parts of the reverberation audio signal.

7. The method as claimed in claim 1, wherein the delay parameter is a pre-delay parameter configured to define a delay value to be applied before starting late reverberation parts of the reverberation audio signal.

8. A method for generating reverberant audio signals, the method comprising:
obtaining a bitstream, the bitstream comprising: at least one reverberation parameter; and at least one reverberation modification parameter;
obtaining at least one audio signal;
generating a reverberant audio signal using processing at least the at least one audio signal based on the at least one reverberation parameter; and
controlling a delay parameter during the generation of the reverberant audio signal based on the at least one reverberation modification parameter, wherein the delay parameter for the reverberant audio signal generation is determined based at least partially on the at least one reverberation modification parameter.

9. The method as claimed in claim 8, wherein the bitstream further comprises the at least one audio signal.

10. The method as claimed in claim 8, wherein controlling the delay parameter during the generation of the reverberant audio signal further comprises determining the delay parameter of late reverberation part of the reverberant audio signal.

11. The method as claimed in claim 10, wherein determining the delay parameter of the late reverberation part of the reverberant audio signal comprises:
determining an initial delay parameter based on the at least one reverberation parameter; and
modifying the initial delay parameter based on the at least one reverberation modification parameter.

12. The method as claimed in claim 11, wherein modifying the initial delay parameter is further based on determining at least one trigger event.

13. The method as claimed in claim 12, wherein the trigger event comprises at least one of:
available bitrate for the bitstream;
computational resources of an apparatus generating the reverberant audio signals;
an early reflection part quality determination; or
an environment scene geometry representation determination.

14. The method as claimed in claim 8, wherein controlling the delay parameter during the generation of the reverberant audio signal further comprises:
determining whether early reflection parts of the reverberant audio signal are to be generated; and
modifying the delay parameter of late reverberation part of the reverberant audio signal with the application of the at least one reverberation modification parameter based on the determining whether early reflection parts of the reverberant audio signal are to be generated.

15. The method as claimed in claim 8, wherein the delay parameter is a pre-delay parameter configured to define a delay value to be applied before starting late reverberation parts of the reverberation audio signal.

16. The method as claimed in claim 8, wherein generating the reverberant audio signal comprises processing at least the at least one audio signal with a reverberator configured using the at least one reverberation parameter.

17-18. (canceled)

19. An apparatus for assisting generating reverberant audio signals, the apparatus comprising:
at least one processor; and
at least one memory storing instructions that, when executed with the at least one processor, cause the apparatus at least to:
obtain at least one reverberation parameter associated with at least one audio signal, the at least one reverberation parameter representing reverberation characteristics to be applied when rendering the associated at least one audio signal;
obtain at least one reverberation modification parameter configured to control a delay parameter during a generation of a reverberant audio signal based on the at least one reverberation parameter; and
output or store a bitstream comprising the at least one reverberation parameter, and the at least one reverberation modification parameter.

20. An apparatus for generating reverberant audio signals, the apparatus comprising:
at least one processor; and
at least one memory storing instructions that, when executed with the at least one processor, cause the apparatus at least to:
obtain a bitstream, the bitstream comprising: at least one reverberation parameter; and at least one reverberation modification parameter;
obtain at least one audio signal;
generate a reverberant audio signal using processing at least the at least one audio signal according to the at least one reverberation parameter; and
control a delay parameter during the generation of the reverberant audio signal based on the at least one reverberation modification parameter, wherein the delay parameter for the reverberant audio signal generation is determined based at least partially on the at least one reverberation modification parameter.

21. The apparatus as claimed in claim 19, wherein the at least one reverberation parameter comprises the delay parameter for late reverberation parts of the reverberation audio signal.

22. The apparatus as claimed in claim 20, wherein the instructions, when executed with the at least one processor, cause the apparatus to determine the delay parameter of late reverberation parts of the reverberant audio signal.
